(19) United States
(12) Patent Application Publication
(10) Pub. No.: US 2010/0299516 A1
(43) Pub. Date: Nov. 25, 2010

(54) CONTENTS PROTECTION PROVIDING METHOD AND PROTECTED CONTENTS CONSUMING METHOD AND APPARATUS THEREOF

(76) Inventors: Seong-Oun Hwang, Daejon (KR); Sangwoo Ahn, Daejon (KR); Jeho Nam, Daejon (KR); Jin-Woo Hong, Daejon (KR)

Correspondence Address: STAAS & HALSEY LLP, SUITE 700, 1201 NEW YORK AVENUE, N.W., WASHINGTON, DC, 20005, US

(21) Appl. No.: 12/678,835

(22) PCT Filed: Aug. 18, 2008
(86) PCT No.: PCT/KR2008/004779

§ 371 Date: May 28, 2010

Related U.S. Application Data
(60) Provisional application No. 60/973,431, filed on Sep. 18, 2007.
(60) Provisional application No. 60/982,764, filed on Oct. 26, 2007.
(60) Provisional application No. 60/984,397, filed on Nov. 1, 2007.
(60) Provisional application No. 60/991,844, filed on Dec. 3, 2007.

(51) Int. Cl. H04L 9/00

(52) U.S. Cl. 713/150

(57) ABSTRACT

The contents protection providing method includes: creating an encrypted stream with encrypted data; creating a key stream including key information for decrypting the encrypted data; creating reference information for connecting the key information to the encrypted data corresponding to the key information; and transmitting the encrypted stream, key stream, and reference information to a terminal.

### TECHNICAL FIELD

The present invention relates to a contents protection providing method, a protected contents consuming method, and an apparatus thereof.

This work was supported by the IT R&D program for MIC/IITA [2007-S-003-01, “Development of Protection Technology for Terrestrial DTV Program”].

### BACKGROUND ART

Problems associated with copyright begins as high-speed internet comes into wide use and users of digital devices such as personal computer (PC) and mobile phone increase, which is different from an environment where traditional analog contents are used. In an analog contents environment, copying contents has not been easy and effective due to quality degradation. However, development of digital technology and expansion of infrastructure makes illegal copying and mass distribution of digital contents easy.

Problems associated with illegal copying are not limited only to the Internet and PC environment. The illegal copying and mass distribution of digital contents have become problems to be solved in both broadcasting and non-broadcasting areas, as the media becomes digitalized.

There are Digital Rights Management (DRM) and copy protection technologies as conventional technical measures for solving these problems. However, effective solutions for preventing the illegal copying and mass distribution of digital contents have not been suggested yet.

### DISCLOSURE

### Technical Problem

An embodiment of the present invention is directed to providing a method and apparatus for efficiently preventing illegal copying and mass distribution of digital contents.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a contents protection providing method, including: creating an encrypted stream with encrypted data; creating a key stream with key information for decrypting the encrypted data; creating reference information for connecting the key information to the encrypted data corresponding to the key information; and transmitting the encrypted stream, key stream, and reference information to a terminal.

In accordance with another aspect of the present invention, there is provided a protected contents consuming method, including: receiving an encrypted stream including encrypted data, a key stream including key information for decrypting the encrypted data, and reference information for connecting the key information to the encrypted data corresponding to the key information; and referring to the reference information and decrypting the encrypted data based on the key information.

In accordance with another aspect of the present invention, there is provided a contents protection providing apparatus, including: an encrypted stream creating unit for creating an encrypted stream with encrypted data; a key stream creating unit for creating a key stream with key information for decrypting the encrypted data; a reference information creating unit for creating reference information for connecting the key information to the encrypted data corresponding to the key information; and a transmitting unit for transmitting the encrypted stream, key stream and reference information to a terminal.

In accordance with another aspect of the present invention, there is provided a protected contents consuming apparatus, including: a receiving unit for receiving an encrypted stream including encrypted data, a key stream including key information for decrypting the encrypted data, and reference information for connecting the key information to the encrypted data corresponding to the key information; and a decrypting unit for referring to the reference information and decrypting the encrypted data based on the key information.

The advantages, features, and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail, hereinafter, with reference to the attached drawings.

### ADVANTAGEOUS EFFECTS

The present invention can efficiently prevent illegal copying and mass distribution of digital contents.

### BRIEF DESCRIPTION OF THE DRAWINGS

FIG. 1 is a block diagram describing a data structure in accordance with an embodiment of the present invention.

FIG. 2 is a block diagram showing a contents protection providing apparatus and a protected contents consuming apparatus in accordance with an embodiment of the present invention.

FIG. 3 is a block diagram showing a structure of an International Organization for Standardization (ISO) base media file in accordance with the embodiment of the present invention.

FIG. 4 is a block diagram showing a track and sample of an ISO base media file format in accordance with an embodiment of the present invention.

### BEST MODE FOR THE INVENTION

A detailed embodiment of the present invention will be described hereafter.

### Embodiment

In the embodiment of the present invention, a method for protecting contents of the International Organization for Standardization (ISO) base media file format generally used, not only on the Internet, but also in a broadcasting environment will be described. The contents protection method suggested in the present invention can be applied to fields using the ISO base media file format as well as a broadcasting field. In other words, the application area of the present invention is not specifically limited to a contents field.

In this embodiment, a case that the present invention protects a broadcasting program based on Digital Video Broadcasting (DVB) Content Protection and Copy Management (CPCM) in a Moving Picture Experts Group 2 Transport Stream (MPEG-2 TS) broadcasting environment will be described.

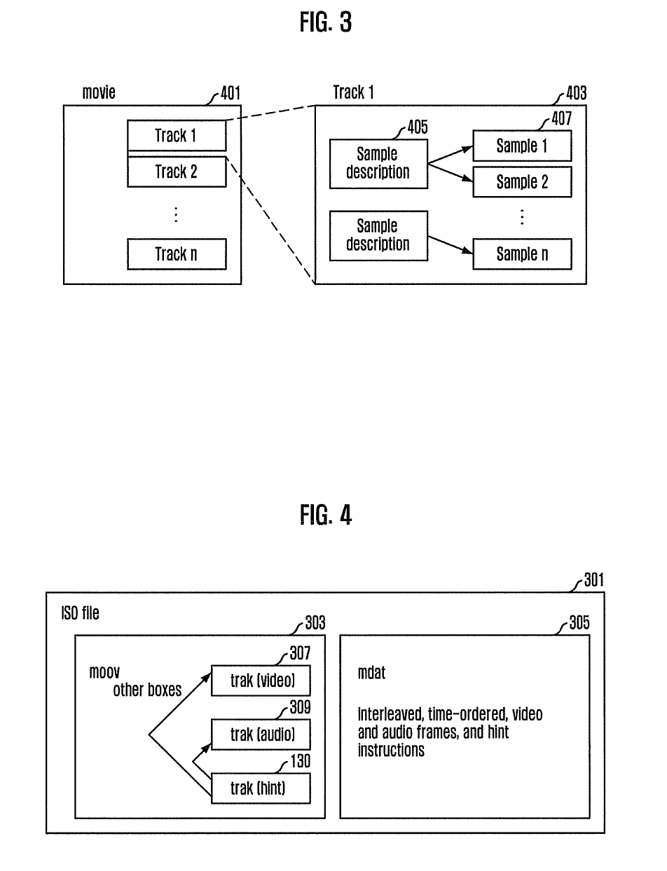

ISO base media file format [ISO/IEC 14496-12: Information technology—Coding of audio-visual objects—Part 12: ISO Base Media File Format, Second Edition, April 2005] describes a general format for other specific file formats. A core concept of the ISO base media file format described in FIG. 3 will be described in brief in FIG. 4.

FIG. 3 is a block diagram showing a structure of the ISO base media file used in accordance with an embodiment described in FIG. 3 of the present invention. Referring to FIG. 4, an ISO base media file 301, includes objects called ‘boxes 303 and 305 ’ and the entire data are described in the boxes.

A box object has size and type information. The size indicates the size of the data included in the box as a byte number and the type means a box identifier formed of 4 letters. Accordingly, the location of the box including the desired information can be easily detected based on the size and type of information.

A moov 303 and a mdat 305 of FIG. 3 are boxes having metadata and media data, respectively. The metadata does not include media data and are just referred to for description. The ISO base media file has a box of a ‘moov’ type including metadata on media stream and a box of a ‘mdat’ type including the actual media data.

FIG. 4 is a block diagram showing a track and sample of the ISO base media file format in accordance with an embodiment of the present invention. In FIG. 4, a movie 401 is a set of consecutive motions where video, such as moving pictures, are integrated with audio. A track 403 shows a time flow of the media and includes a sample 407 and a sample description 405. The sample 407 means a small unit such as a frame of video and the sample description 405 defines information on how the samples 407 are decrypted. There are video tracks, audio tracks, and hint tracks as examples of various kinds of tracks. The video tracks or the audio tracks includes metadata on video or audio. The hint tracks describes information on how a streaming server performs streaming or packetizing on video and audio samples when the ISO base media file is streamed based on a streaming protocol. When the ISO base media file is restored, the hint tracks may be ignored.

MPEG is a standard protocol made by the International Standard Organization/International Electro-technical Commission (ISO/IEC) Joint Technical Committee One (JTC1) affiliated committee SC29/WG11, which is related to a general technology for compressing, coding and transmitting multimedia data such as moving pictures and voice signals. MPEG-2 is a more generalized standard protocol ISO/IEC 13818 made in 1995, and it is suggested for applying the video and audio technology to communication and broadcasting media as well as storing video in digital storage such as compact disc (CD) and video tape recorder (VTR). MPEG-2 Transport Stream (TS) is a packetizing procedure of MPEG-2 for configuring a plurality of broadcasting programs into a multiplexed stream within a channel environment having an error and transmitting or broadcasting the stream through a network. The MPEG TS packet is a 188-byte fixed length packet and the consecutive streams of the TS packet are called Transport Stream (TS).

Generally, specific data such as contents are statistically connected to a specific key, a decrypting key on the contents, from beginning to end, and a decrypting key on the contents are loaded in a license and transmitted to a final user.

However, when the data is transmitted in a stream format, there is a case when the contents are encrypted while the decrypting key is continuously updated. For example, there is a method for dynamically updating a key such as Conditional Access System (CAS). In an environment where the key is dynamically updated, it is more efficient to store the updated key as an individual key stream than to load and transmit the updated key in a file, i.e., a license. Therefore, a mechanism using a dynamic key stream will be described in the embodiment of the present invention.

A provider for providing contents protection creates encrypted stream including encrypted data, key stream including key information for decrypting encrypted data, reference information for connecting key information to the encrypted data corresponding to the key information. The created encrypted stream, key stream, and reference information is transmitted to a contents consuming terminal. The encrypted data are transmitted in parallel to the key information. The encrypted data includes audio or video contents. The encrypted data is metadata for describing audio or video contents.

The key information transmitted to the terminal is stored in a key track. The key track may be a timed metadata track. The key track is linked with a reception hint track or an elementary stream media track. The reception hint track may be a Real-time Transport Protocol (RTP) reception hint track.

A sample, ‘ench,’ is used as an entry type of an MPEG-2 TS reception hint track. In the ISO base media file format, [ISO/IEC 14496-12: Information technology—Coding of audio-visual objects—Part 12: ISO Base Media File Format, Second Edition, April 2005], ‘encv,’ ‘enca,’ ‘enct,’ and ‘encs’ are defined and used in case of video, audio, text, and a system, respectively.

The key information is transmitted in parallel to the encrypted data to transmit a key required to decrypt the encrypted data. The key stream is stored in a key message reception track, while the encrypted data is recorded. A key stream transmitted from the provider to the terminal is stored in the key message reception track based on Timed Metadata Track [ISO/IEC 14496-12: Information technology—Coding of audio-visual objects—Part 12: ISO Base Media File Format, Amendment 1 to Second Edition (2005), April 2007].

A packet on key information is stored as a sample. It is called a key sample. The key message reception track is based on a timed metadata track. The reference information is used to connect a reception hint track corresponding to the key track or an elementary stream media track. In the present embodiment, the reference information uses ‘cdsc’ as a track reference type. The reference information includes track_ID information for identifying each track and reference type information for specifying a track type.

The key message reception track is defined by a key message reception sample entry, which is an entry format of a sample description. The key message reception sample entry uses a metadata sample entry defined in [ISO/IEC 14496-12: Information technology—Coding of audio-visual objects—Part 12: ISO Base Media File Format, Amendment 1 to Second Edition (2005), April 2007]. The key message reception sample entry includes key_sample_type, key_sample_version and additional data. An entry format, ‘keym,’ is used as a sample description for the key message reception track.

A key sample format is transmitted by key-sample-type information and key-sample-version information. The key sample type information is identifier information of the key sample type. The key sample version information is for identifying a key sample entry version for the key sample type transmitted in the key sample type. Table 1 is an example of a key sample type identifier.

TABLE 1

| Key sample type | Protection system |
|---|---|
| 1 | DVB-H OSF ECM key message type |
| 2 | DVB-H SPP 18C KSM key message |
| | type |
| 3-254 | Reserved for future use |
| 255 | Proprietary key message type |
| | specified with UUIS |

Referring to Table 1, a protocol is defined and used such that a DVB-H OSF ECM key message type is expressed when key_sample_type is 1 and a DVB-H SPP 18C KSM key message type is expressed when key_sample_type is 2.

A key message included in the key information is called a key stream message and is used as Short Term Key Messages (STKMs) in 18 Crypt and Entitlement Control Messages (ECMs) in Open Security Framework (OSF).

The following is an example of a sample syntax description for the key message reception track:

| | | |
|---|---|---|
| class | KeyMessageReceptionSampleEntry( ) | extends |

MetadataSampleEntry(‘keym’) {

unsigned int(8) key_sample_type;
unsigned int(8) key_sample_version;
if (key_sample_type == 0xFF) {
unsigned int(8) uuid[16];
}
box additionaldata[ ];
}

‘additionaldata’ includes a plurality of information additionally managed in the key management method where ‘uuid’ is for registering and using Universally UniqueIdentifier (UUID) in a key management method to show a self key management method.]

In the key message reception track, each sample shows key information without an additional header. The key information is capsulated as a User Datagram Protocol (UDP) packet. In this case, the UDP packet is capsulated without the additional header. A sample time of the key information is a reception time of the received packet.

The present invention uses key management information including access right information for accessing the key information. The key management information includes access right information on contents or a service and allows an authorized user to access the key information. A format of the key management information is defined by a key management system. The access right information included in the key management information is called key management message (KMMs) and is used as Long Term Key Messages (LTKMs) in 18 Crypt and Entitlement Management Messages (EMMs) in Open Security Framework (OSF).

The key management message is stored in an item information box defined in [ISO/IEC 14496-12: Information technology—Coding of audio-visual objects—Part 12: ISO Base Media File Format, Amendment 1 to Second Edition (2005), April 2007]. To be specific, the key management message is stored in a Meta box having a handler type ‘skmm’.

The key management message includes key_management_message_type, key_management_message_version and additional data. The key management message type information includes identifier information of the key management system. The key management message version information is for identifying the version of the key management message.

The following is an example of a syntax for storing the key management message:

| | | |
|---|---|---|
| class | SKMMItemInfoExtension( ) | extends |

ItemInfoExtension(‘skid’) {

unsigned int(8) key_management_message_type;
unsigned int(8) key_management_message_version;
if (key_sample_type == 0xFF) {
unsigned int(8) uuid[16];
}
box additionaldata[ ];
}

The above encrypted stream and key stream are transmitted according to a Real-time Transport Protocol (RTP) method. Also, as described above, encrypted data, key information, and reference information are defined in an ISO base media file format.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art, further description will not be provided herein.

While the present invention has been described with respect to certain preferred embodiments, it will be apparent to those skilled in the art that various changes and modifications may be made without departing from the scope of the invention as defined in the following claims.

### MODE FOR THE INVENTION

The following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

In addition, all of the detailed description on the principles, viewpoints, embodiments, and particular embodiments of the present invention should be understood to include structural and functional equivalents to them. The equivalents include not only currently known equivalents, but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all of the flowcharts, state conversion diagrams, pseudo codes, and the like can be expressed substantially in a computer-readable media, and whether or not a computer or a processor is described distinctively, they should be understood to express various processes operated by a computer or a processor.

Functions of various devices illustrated in the drawings including a functional block expressed as a processor, or a similar concept can be provided not only by using hardware dedicated to the functions, but also by using hardware capable of running proper software for the functions. When a function is provided by a processor, the function may be provided by a single dedicated processor, single shared processor, or a plurality of the individual processors; a part of which can be shared.

The apparent use of a term, ‘processor,’ ‘control,’ or similar concept, should not be understood to exclusively refer to a piece of hardware capable of running software, but should be understood to include a digital signal processor (DSP), hardware, ROM, RAM, and non-volatile memory for storing software, implicatively. Other known and commonly used hardware may be included therein as well.

In the claims of the present specification, an element expressed as a means for performing a function described in the detailed description is intended to include all of the methods for performing the function including all of the formats for the software, such as combinations of circuits for performing the intended function, firmware/microcode and the like. To perform the intended function, the element is [cooperated (combined, joined,)] with a proper circuit for performing the software. The present invention defined by the claims includes diverse means for performing specific functions, and the means are connected with each other in a method described in the claims. Therefore, any means that can provide the function should be understood to be an equivalent to what is figured out from the present specification.

The advantages, features, and aspects of the invention will become apparent from the following description of the embodiments with reference to the accompanying drawings, which is set forth, hereinafter. Therefore, those skilled in the field of this art of the present invention can embody the technological concept and scope of the invention easily. In addition, if it is considered that the detailed description on a related art may obscure the points of the present invention, the detailed description will not be provided, herein. The preferred embodiments of the present invention will be described in detail, hereinafter, with reference to the attached drawings.

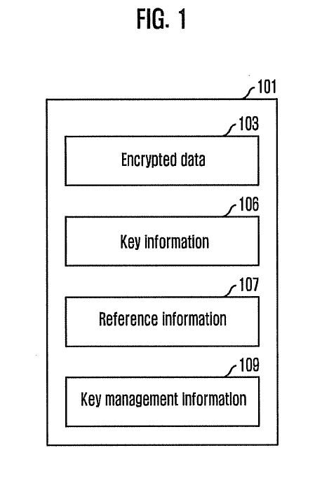

FIG. 1 is a block diagram describing a data structure in accordance with an embodiment of the present invention.

A data structure 101 in accordance with the present invention is for a mechanism that when data are encrypted and transmitted, key information 106 decrypting encrypted data 103 is transmitted in parallel and the data are protected. The data include media contents such as audio or video. The data include metadata describing media contents and digital data have no limitation.

In the present invention, the encrypted data 103 is created as an encrypted stream and the key information 106 for decrypting the encrypted data 103 is created as a key information stream. Reference information 107 is created to connect the encrypted data 103 and the key information 106.

The encrypted data 103, the key information 106, and the reference information 107 are created by a provider providing contents protection and transmitted to a terminal consuming contents. The terminal receives the encrypted data 103, the key information 106 and the reference information 107, connects the encrypted data 103 and the key information 106 based on the reference information 107, and decrypts the encrypted data 103.

The encrypted data 103 is a reception hint track or an elementary stream media track. Meanwhile, the key information 106 is information based on timed metadata.

The key information 106 includes identifier information, key version information, and Universally Unique Identifier (UUID). Also, the key information 106 is capsulated as a User Datagram Protocol (UDP) packet.

Meanwhile, the present invention further includes a procedure of creating key management information 109 including access right information capable of accessing to the key information 106. In this case, the key management information 109 is transmitted to the terminal.

The encrypted stream and the key stream are transmitted according to a Real-time Transport Protocol (RTP) method.

The encrypted data 103, the key information 106, and the reference information 107 are defined in an ISO base media file format.

The present invention is realized as methods including a contents protection providing method and a protected contents consuming method, or apparatuses including a contents protection providing apparatus and a protected contents consuming apparatus. The methods and apparatuses realized by the present invention will be described, hereinafter.

<Contents Protection Providing Method and Protected Contents Consuming Method>

The present invention is realized in a system including a provider providing contents protection and a terminal receiving contents.

The contents protection providing method and the protected contents consuming method respectively performed in the provider and the terminal will be described.

The contents protection providing method in accordance with the present invention includes creating an encrypted stream including encrypted data, creating a key stream including key information for decrypting the encrypted data, creating reference information for connecting the key information to the encrypted data corresponding to the key information, and transmitting the encrypted stream, key stream and reference information to a terminal. The encrypted data is a reception hint track or an elementary stream media track.

The key information is information based on timed metadata. Also, the key information includes identifier information of a key type, key version information, and Universally UniqueIdentifier (UUID). The key information is capsulated as a User Datagram Protocol (UDP) packet.

The contents protection providing method in accordance with the present invention further includes creating key management information including access right information capable of accessing to the key information. In this case, in transmitting the encrypted stream, key stream and reference information, the key management information is transmitted to the terminal.

The encrypted stream and the key stream are transmitted according to a Real-time Transport Protocol (RTP) method. The encrypted data, key information, and reference information are defined in an International Organization for Standardization (ISO) base media file format.

The protected contents consuming method in accordance with the present invention includes receiving an encrypted stream including encrypted data, a key stream including key information for decrypting the encrypted data, and reference information for connecting the key information to the encrypted data corresponding to the key information, and referring to the reference information and decrypting the encrypted data based on the key information. (The previous sentence is too long and it uses too many “and.” Therefore, it is awkward and doesn't make any sense.) The encrypted data is a reception hint track or an elementary stream media track.

The key information is information based on timed metadata. Also, the key information includes identifier information of a key type, key version information and UUID. The key information is capsulated as a UDP packet.

The protected contents consuming method in accordance with the present invention further includes creating key management information including access right information capable of accessing the key information. In transmitting the encrypted stream, key stream, and reference information, the key management information is transmitted to the terminal.

The encrypted stream and the key stream are transmitted according to the RTP method. The encrypted data, key information and reference information are defined in the ISO base media file format.

<Contents Protection Providing Apparatus and Protected Contents Consuming Apparatus>

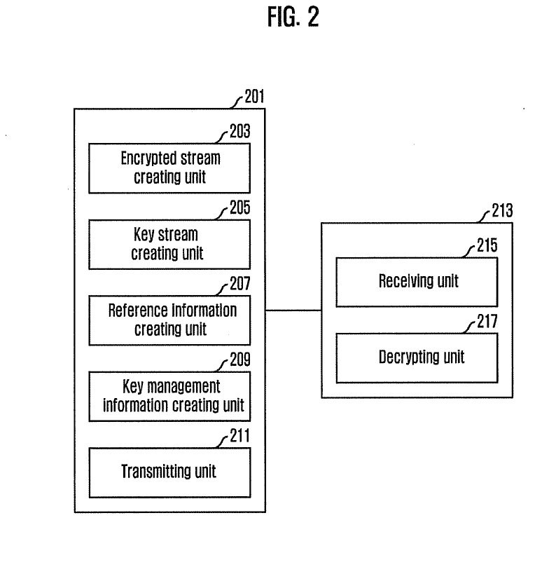

The present invention is realized as a system including a provider providing contents protection and a terminal receiving contents. FIG. 2 is a block diagram showing the contents protection providing apparatus and the protected contents consuming apparatus in accordance with an embodiment of the present invention. It will be described with reference to FIG. 2.

A contents protection providing apparatus 201 in accordance with the present invention includes an encrypted stream creating unit 203 for creating an encrypted stream including encrypted data, a key stream creating unit 205 for creating a key stream including key information for decrypting encrypted data, a reference information creating unit 207 for creating reference information for connecting the key information to encrypted data corresponding to the key information, a transmitting unit 211 for transmitting the encrypted stream, the key stream and the reference information to a terminal 213. The encrypted data may be a reception hint track or an elementary stream media track.

The key information is information based on timed metadata. Also, the key information includes identifier information of a key type, key version information, and Universally UniqueIdentifier (UUID). The key information is capsulated as a User Datagram Protocol (UDP) packet.

The contents protection providing apparatus in accordance with the present invention further includes a key management information creating unit 211 for creating key management information including access right information capable of accessing the key information. In this case, the key management information creating unit 211 transmits key management information to the terminal 213.

The encrypted stream and the key stream are transmitted according to a Real-time Transport Protocol (RTP) method and the encrypted data, the key information and the reference information are defined in an ISO base media file format.

The protected contents consuming apparatus 213 in accordance with the present invention includes a receiving unit 215 for receiving an encrypted stream including encrypted data, a key stream including key information for decrypting encrypted data, reference information for connecting key information to the encrypted data corresponding to the key information, and a decrypting unit 217 for referring to the reference information and decrypting encrypted data based on the key information. The encrypted data may be a reception hint track or an elementary stream media track.

The key information is information based on timed metadata. Also, the key information includes identifier information of a key type, key version information, and UUID. The key information is capsulated as a UDP packet.

The receiving unit 215 of the protected contents consuming apparatus in accordance with the present invention receives key management information including access right information capable of accessing the key information.

The encrypted stream and the key stream are transmitted according to the RTP method and the encrypted data, the key information and the reference information are defined in the ISO base media file format.

### INDUSTRIAL APPLICABILITY

The present invention is applied to efficiently prevent illegal copying and mass distribution of digital contents.

1. A contents protection providing method, comprising:
creating an encrypted stream including encrypted data;
creating a key stream including key information for decrypting the encrypted data;
creating reference information for connecting the key information to the encrypted data corresponding to the key information; and
transmitting the encrypted stream, key stream, and reference information to a terminal.

2. The method of claim 1, wherein the encrypted data is a reception hint track or an elementary stream media track.

3. The method of claim 1, wherein the key information is information based on timed metadata.

4. The method of claim 1, wherein the key information includes identifier information of a key type, key version information and Universally UniqueIdentifier (UUID).

5. The method of claim 1, wherein the key information is capsulated as a User Datagram Protocol (UDP) packet.

6. The method of claim 1, further comprising:
creating key management information including access right information capable of accessing the key information,
wherein the said transmitting encrypted stream, key stream, reference information, and the key management information is transmitted to the terminal.

7. The method of claim 1, wherein the encrypted stream and the key stream are transmitted according to a Real-time Transport Protocol (RTP) method.

8. The method of claim 1, wherein the encrypted data, key information and reference information are defined in an International Organization for Standardization (ISO) base media file format.

9. A protected contents consuming method, comprising:
receiving an encrypted stream including encrypted data, a key stream including key information for decrypting the encrypted data, and reference information for connecting the key information to the encrypted data corresponding to the key information; and
referring to the reference information and decrypting the encrypted data based on the key information.

10. The method of claim 9, wherein the encrypted data is a reception hint track or an elementary stream media track.

11. The method of claim 9, wherein the key information is information based on timed metadata.

12. The method of claim 9, wherein the key information includes identifier information of a key type, key version information and Universally UniqueIdentifier (UUID).

13. The method of claim 9, wherein the key information is capsulated as a User Datagram Protocol (UDP) packet.

14. The method of claim 9, further comprising:
receiving key management information including access right information capable of accessing to the key information.

15. The method of claim 9, wherein the encrypted stream and the key stream are transmitted according to a Real-time Transport Protocol (RTP) method.

16-32. (canceled)

33. The method of claim 9, wherein the encrypted data, key information, and reference information are defined in an International Organization for Standardization (ISO) base media file format.

34. A contents protection providing apparatus, comprising:
an encrypted stream creating unit for creating an encrypted stream including encrypted data;
a key stream creating unit for creating a key stream including key information for decrypting the encrypted data;
a reference information creating unit for creating reference information for connecting the key information to the encrypted data corresponding to the key information; and
a transmitting unit for transmitting the encrypted stream, key stream and reference information to a terminal.

35. A protected contents consuming apparatus, comprising:
a receiving unit for receiving an encrypted stream including encrypted data, a key stream including key information for decrypting the encrypted data, and reference information for connecting the key information to the encrypted data corresponding to the key information; and
a decrypting unit for referring to the reference information and decrypting the encrypted data based on the key information.
